(19) United States
(12) Patent Application Publication
(10) Pub. No.: US 2021/0084224 A1
(43) Pub. Date: Mar. 18, 2021

(54) UNMANNED AERIAL VEHICLE CONTROL METHOD AND UNMANNED AERIAL VEHICLE

(71) Applicant: SZ DJI TECHNOLOGY CO., LTD., Shenzhen (CN)

(72) Inventors: Yingzhi WANG, Shenzhen (CN); Shuai LIU, Shenzhen (CN); Zhendong WANG, Shenzhen (CN)

(73) Assignee: SZ DJI TECHNOLOGY CO., LTD., Shenzhen (CN)

(21) Appl. No.: 17/107,868

(22) Filed: Nov. 30, 2020

Related U.S. Application Data
(63) Continuation of application No. PCT/CN2018/096610, filed on Jul. 23, 2018.

(51) Int. Cl. H04N 5/232; H04N 5/225; G05D 1/00; B64D 47/08; G03B 17/56; B64C 39/02

(52) U.S. Cl. CPC H04N 5/23258; H04N 5/225251; G05D 1/0022; G05D 1/0094; B64C 2201/146; G03B 17/561; B64C 39/024; B64C 2201/127; B64D 47/08

(57) ABSTRACT

The present disclosure provides an unmanned aerial vehicle control method and an unmanned aerial vehicle. The unmanned aerial vehicle control method includes: determining that the unmanned aerial vehicle is in a first mode, where the first mode includes a mode in which the unmanned aerial vehicle moves following the rotation of the gimbal; and after determining that the gimbal is in a specific working condition, entering an exception handling procedure. According to the present disclosure, when the unmanned aerial vehicle is in the first mode, if the gimbal is in the specific working condition, which may cause the unmanned aerial vehicle to generate a spinning phenomenon, the unmanned aerial vehicle enters the exception handling procedure. Therefore, the spinning problem of the unmanned aerial vehicle is avoided, and a risk of crashing of the unmanned aerial vehicle is also avoided.

### RELATED APPLICATIONS

This application is a continuation application of PCT application No. PCT/CN2018/096610, filed on Jul. 23, 2018, and the content of which is incorporated herein by reference in its entirety.

### TECHNICAL FIELD

The present disclosure relates to the field of unmanned aerial vehicle, and in particular, to an unmanned aerial vehicle control method and an unmanned aerial vehicle.

### BACKGROUND

An existing unmanned aerial vehicle includes two operating modes: a gimbal rotates following the moving of the unmanned aerial vehicle, and the unmanned aerial vehicle moves following rotation of the gimbal. In the mode where the gimbal rotates following the moving of the unmanned aerial vehicle, when a flight controller of the unmanned aerial vehicle receives a control amount (also referred to as an amount of control lever displacement) sent by a remote control, the flight controller calculates a corresponding speed based on the received control amount, and then superimposes this speed to a posture of the unmanned aerial vehicle. After the gimbal receives a posture change of the unmanned aerial vehicle, the gimbal rotates following the moving of the unmanned aerial vehicle. Since the flight controller needs to mainly ensure the stability and does not have a high requirement on precision, this mode is usually adopted. However, at the moment of starting to push a joystick and the moment of suddenly releasing the joystick, due to a control precision issue of the flight controller, an image shot by a photographing device on the gimbal may suddenly jitter, causing the image unusable. To overcome this problem, the mode in which the unmanned aerial vehicle moves following rotation of the gimbal is generally used to replace the mode in which the gimbal rotates following the moving of the unmanned aerial vehicle.

In the mode where the unmanned aerial vehicle moves following the rotation of the gimbal, when the joystick of the remote control is pushed, after the flight controller receives a control amount from the remote control, the flight controller calculates a corresponding speed, and sends the speed to the gimbal to control a posture of the gimbal. After the unmanned aerial vehicle receives a posture change of the gimbal, the unmanned aerial vehicle moves following the rotation of the gimbal, that is, the gimbal moves, and then the unmanned aerial follows. Since the gimbal has higher precision, the image stability can be ensured. However, in some special cases, a target speed may be superimposed on the gimbal all the time. Consequently, the unmanned aerial vehicle always rotates following the rotation of the gimbal, and a spinning phenomenon is thus generated. In a severe case, the unmanned aerial vehicle may even crash.

### SUMMARY

The present disclosure provides an unmanned aerial vehicle control method and an unmanned aerial vehicle.

In a first aspect, the present disclosure provides a method of controlling an unmanned aerial vehicle, wherein an unmanned aerial vehicle carries a gimbal, including determining that the unmanned aerial vehicle is in a first mode, wherein the first mode includes a mode in which the unmanned aerial vehicle moves following rotation of the gimbal; and after determining that the gimbal is in a specific working condition, entering an exception handling procedure.

In a second aspect, the present disclosure provides an unmanned aerial vehicle, including: a body; a gimbal, carried on the body; at least one storage medium to store a set of instructions for controlling the unmanned aerial vehicle; and at least one processor in communication with the at least one storage medium and the gimbal to execute, during an operation, the set of instructions to: determine that the unmanned aerial vehicle is in a first mode, wherein the first mode includes a mode in which the unmanned aerial vehicle moves following rotation of the gimbal; and after determining that the gimbal is in a specific working condition, enter an exception handling procedure.

According to exemplary embodiments of the present disclosure, when the unmanned aerial vehicle is in the first mode, if the gimbal is in the specific working condition, which may cause the unmanned aerial vehicle to generate a spinning phenomenon, the unmanned aerial vehicle enters the exception handling procedure. Therefore, the spinning problem of the unmanned aerial vehicle is avoided, and a risk of crashing of the unmanned aerial vehicle is also avoided.

### BRIEF DESCRIPTION OF THE DRAWINGS

To describe the technical solutions in the embodiments of the present disclosure more clearly, the following briefly describes the accompanying drawings required for describing exemplary embodiments. Apparently, the accompanying drawings in the following description show merely some exemplary embodiments of the present disclosure, and a person of ordinary skill in the art may still derive other drawings from these accompanying drawings without creative efforts.

FIG. 1 is a diagram of an application scenario of an unmanned aerial vehicle control method according to some exemplary embodiments of the present disclosure;

FIG. 2 is a schematic flowchart of an unmanned aerial vehicle control method according to some exemplary embodiments of the present disclosure;

FIG. 3 is a schematic flowchart of a specific implementation of an unmanned aerial vehicle control method according to some exemplary embodiments of the present disclosure;

FIG. 4 is a schematic diagram of communication between a flight controller and a gimbal according to some exemplary embodiments of the present disclosure;

FIG. 5 is a schematic flowchart of a specific implementation of an unmanned aerial vehicle control method according to some exemplary embodiments of the present disclosure; and

FIG. 6 is a structural block diagram of an unmanned aerial vehicle according to some exemplary embodiments of the present disclosure.

### DETAILED DESCRIPTION

The following clearly and describes the technical solutions in some exemplary embodiments of the present disclosure with reference to the accompanying drawings. Apparently, the described exemplary embodiments are merely some but not all of the embodiments of the present disclosure. All other embodiments obtained by a person of ordinary skill in the art based on the exemplary embodiments of the present disclosure without creative efforts shall fall within the scope of protection of the present disclosure.

The following describes in detail an unmanned aerial vehicle control method and an unmanned aerial vehicle in the present disclosure with reference to the accompanying drawings. Under a condition that no conflict occurs, the following exemplary embodiments and features may be combined.

In some exemplary embodiments of the present disclosure, referring to FIG. 1, an unmanned aerial vehicle may include a body, a flight controller 100 disposed on the body, a gimbal 200 carried on the body, and a photographing device 300, where the photographing device 300 is carried on the body of the unmanned aerial vehicle via the gimbal 200.

The gimbal 200 may be a single-axis gimbal or a two-axis gimbal, or may be a three-axis gimbal or a four-axis gimbal. The photographing device 300 in this exemplary embodiment is not limited to a camera in a conventional sense. Specifically, the photographing device 300 may be an image capture device or a photographing device (such as a camera, a video recorder, an infrared photographing device, an ultraviolet photographing device, or a similar device), an audio capture device (for example, a parabolic microphone), or the like. The photographing device 300 may provide static sensing data (such as a picture) or dynamic sensing data (such as a video).

The gimbal 200 is communicatively connected to the flight controller 100, for example, communicatively connected through a controller area network (CAN) bus or another mode. The flight controller 100 may be used to control the rotation of the gimbal 200, so as to control rotation of the photographing device 300 carried on the gimbal 200. In addition, in some exemplary embodiments, the photographing device 300 is communicatively connected to the flight controller 100. For example, the photographing device 300 may be directly communicatively connected to the flight controller 100, or the photographing device 300 may be communicatively connected to the flight controller 100 via the gimbal 200. The flight controller 100 may be used to control the operation of the photographing device 300, obtain an image from the photographing device 300, or the like.

In some exemplary embodiments, the unmanned aerial vehicle may further include a power assembly 400. In this exemplary embodiment, the power assembly 400 may include one or more rotators, propellers, blades, motors, electronic speed adjusters, and so on. For example, a rotator of the power assembly 400 may be a self-tightening rotator, a rotator assembly, or another type of rotator power unit. The unmanned aerial vehicle may have one or more power assemblies 400. All the power assemblies 400 may be of the same type. In some examples, the one or more power assemblies 400 may be of different types. The power assembly 400 may be mounted on the unmanned aerial vehicle by appropriate means, for example, by using a support component (such as a drive shaft). The power assembly 400 may be mounted in any appropriate position of the unmanned aerial vehicle, for example, a top end, a lower end, a front end, a rear end, a lateral side, or any combination thereof. The one or more power assemblies 400 are controlled to control the flight of the unmanned aerial vehicle.

In some exemplary embodiments, the flight controller 100 may be communicatively connected to a terminal 500. The terminal 500 may provide control data for one or more of the flight controller 100, the gimbal 200, and the photographing device 300, and receive information (for example, position and/or motion information of the flight controller 100, the gimbal 200, and the photographing device 300, and image data captured by the photographing device 300) from one or more of the flight controller 100, the gimbal 200, and the photographing device 300.

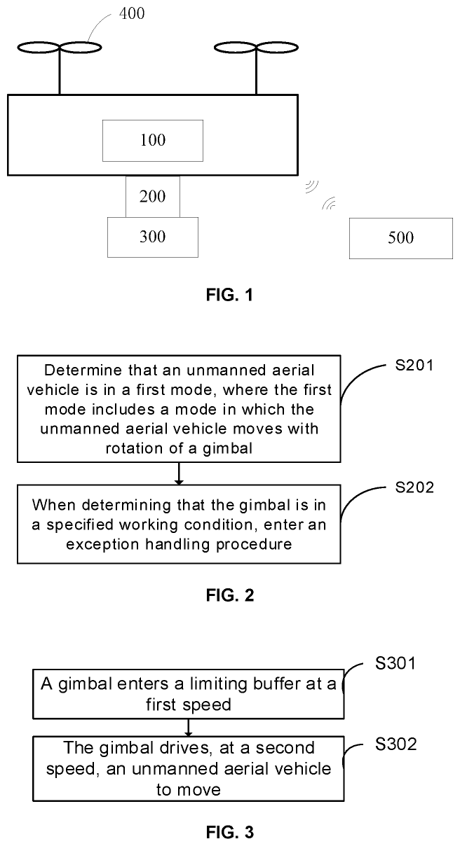

In the following exemplary embodiment, an unmanned aerial vehicle control method is described in detail. It should be noted that the unmanned aerial vehicle control method in this exemplary embodiment of the present disclosure is performed by an unmanned aerial vehicle, for example, a flight controller 100, or a flight controller 100 and a gimbal controller, or an independent controller provided on the unmanned aerial vehicle. As shown in FIG. 2, the unmanned aerial vehicle control method in this exemplary embodiment of the present disclosure may include the following steps.

Step S201: Determine that an unmanned aerial vehicle is in a first mode.

The first mode includes a mode in which the unmanned aerial vehicle moves following a rotation of the gimbal 200.

When the unmanned aerial vehicle is in the first mode, a posture of the unmanned aerial vehicle changes with a posture change of the gimbal 200.

Step S202: After determining that the gimbal 200 is in a specific working condition, enter an exception handling procedure.

Step S202 is performed after step S201.

In this exemplary embodiment of the present disclosure, when the unmanned aerial vehicle is in the first mode, if the gimbal 200 is in the specific working condition, which may cause the unmanned aerial vehicle to have a spinning problem, the unmanned aerial vehicle enters the exception handling procedure. Therefore, the spinning problem of the unmanned aerial vehicle can be avoided, and thus a risk of crashing of the unmanned aerial vehicle is also avoided.

This exemplary embodiment includes a plurality of specific working conditions. For example, the gimbal 200 collides with a mechanical limiting position, or a communication link between the flight controller 100 and the gimbal 200 fails. The following describes each specific working condition in detail.

(1) The gimbal 200 collides with the mechanical limiting position.

Referring to FIG. 3, the determining that the gimbal 200 is in a specific working condition may include, but is not limited to, the following steps.

Step S301: Determine that the gimbal 200 enters a limiting buffer zone at a first speed.

Step S302: Determine that the gimbal 200 drives, at a second speed, the unmanned aerial vehicle to move.

Generally, the gimbal 200 has a mechanical limiting position (for limiting the rotation of the gimbal 200 on a yaw axis). When the unmanned aerial vehicle is in the first mode, if a speed is provided for the gimbal 200 for moving toward the mechanical limiting position, this may cause the gimbal 200 to move all the time until the limiting position is reached; due to speed superimposition of the gimbal 200, a motor of the gimbal 200 always outputs a torque, and the motor of the gimbal 200 is thus subject to a risk of stalling and motor burnout. Therefore, an avoidance speed in an opposite direction needs to be superimposed, so that the motor of the gimbal 200 is not stalled due to collision with the mechanical limiting position.

To avoid the gimbal 200 from colliding with the mechanical limiting position, generally a range at an angle from the mechanical limiting position is set as a buffer zone. When the gimbal 200 moves into the range of the buffer zone, the gimbal 200 generates an avoidance speed opposite to a limiting direction, so that the gimbal 200 moves away from the limiting position.

When the unmanned aerial vehicle is in the first mode, assuming that the gimbal 200 is deadlocked in a mechanical limiting position, the gimbal 200 will generate an avoidance speed. Since the posture of the gimbal 200 changes, the posture of the unmanned aerial vehicle would also changes. Therefore, the gimbal 200 stays in the buffer zone. In this case, the unmanned aerial vehicle would have a spinning phenomenon. That the gimbal 200 is deadlocked in the mechanical limiting position may include the following several cases:

1. When the power of the flight controller 100 is saturated, a joystick of a remote control is operated to indicate a change in a yaw posture of the unmanned aerial vehicle. In this case, the unmanned aerial vehicle is in the first mode, the gimbal 200 rotates but the power of the flight controller 100 is saturated, accordingly, the unmanned aerial vehicle cannot follow the gimbal 200 to rotate. As a result, as the unmanned aerial vehicle cannot follow the gimbal 200 to rotate the gimbal 200 is deadlocked in the mechanical limiting position.

2. To ensure that an image shot by a user is not blurry, in a photographing process, a photographing device 300 may lock the gimbal 200, so that the gimbal 200 enters a temporary free state. In such a case, if a long exposure time is required and the yaw posture of the unmanned aerial vehicle changes during the photographing process, the gimbal 200 to be deadlocked in the mechanical limiting position due to user operation.

3. Other exceptional cases such as posture divergence (that is, an extended Kalman filter EKF method is used in posture estimation of the gimbal 200, in a special case, such as a case of great noise, the algorithm may not converge but diverges) may cause an inaccurate posture of the gimbal 200. Thus, even if the posture of the gimbal 200 is commanded to be the posture of the unmanned aerial vehicle, the gimbal 200 may be still deadlocked at/near the mechanical limiting position.

In step S301, the first speed is a speed of controlling the gimbal 200 to move toward the mechanical limiting position. In step S302, the second speed is a combined speed of the speed of controlling the gimbal 200 to move toward the mechanical limiting position and an avoidance speed to avoid the gimbal 200 from colliding with the mechanical limiting position. In some examples, the second speed is equal to the speed of controlling the gimbal 200 to move toward the mechanical limiting position minus the avoidance speed. In addition, this exemplary embodiment can further avoid an overload problem of the gimbal 200 caused by collision of the gimbal 200 with the mechanical limiting position.

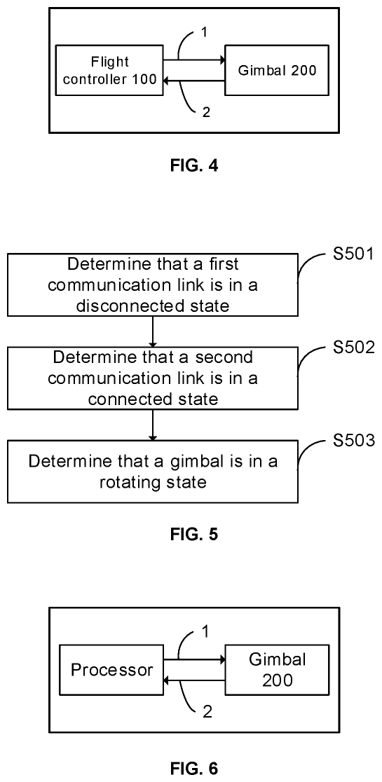

Referring to FIG. 4, the flight controller 100 and the gimbal 200 in this exemplary embodiment may implement bidirectional communication via two communication links (hardware lines). Specifically, the communication links include a first communication link 1 and a second communication link 2. The flight controller 100 transmits data (such as a control amount sent by the remote control to the unmanned aerial vehicle, the posture of the unmanned aerial vehicle, or other data of the unmanned aerial vehicle) of the unmanned aerial vehicle to the gimbal 200 through the first communication link 1, and the gimbal 200 transmits data (such as the posture of the gimbal 200, a rotation speed of the gimbal 200, or other data of the gimbal 200) of the gimbal 200 to the unmanned aerial vehicle through the second communication link 2. Further, the determining that the gimbal 200 is in a specific working condition further includes: determining that the first communication link 1 and the second communication link 2 are both in a connected state. When the flight controller 100 normally communicates with the gimbal 200, the gimbal has an avoidance speed, and the unmanned aerial vehicle may have a spinning problem. This spinning problem can be avoided by controlling the unmanned aerial vehicle to enter the exception handling procedure.

Further, in some exemplary embodiments, after it is determined that the gimbal 200 is in the specific working condition, if it is further determined that the unmanned aerial vehicle has not received a speed control instruction sent by a remote control device, the unmanned aerial vehicle enters the exception handling procedure. In some exemplary embodiments, after it is determined that the gimbal 200 is in the specific working condition, if it is further determined that the unmanned aerial vehicle has received a speed control instruction sent by a remote control device, where the speed control instruction includes that a yaw speed of the unmanned aerial vehicle is 0, the unmanned aerial vehicle enters the exception handling procedure. In foregoing two exemplary embodiments, no external device controls the yaw speed of the unmanned aerial vehicle, and the yaw posture of the unmanned aerial vehicle changes with the change of the yaw posture of the gimbal 200, and therefore a spinning problem is generated.

Still further, that the unmanned aerial vehicle enters the exception handling procedure may include a plurality of handling modes, for example, in some exemplary embodiments, controlling the unmanned aerial vehicle to switch from the first mode to a second mode. The second mode includes a mode in which the gimbal 200 rotates following the moving of the unmanned aerial vehicle. When the unmanned aerial vehicle is in the second mode, the posture of the gimbal 200 changes with the posture change of the unmanned aerial vehicle. In addition, in this exemplary embodiment, after the unmanned aerial vehicle is controlled to switch from the first mode to the second mode, when a current distance between the gimbal 200 and the limiting buffer zone is greater than a specified distance threshold, the unmanned aerial vehicle may be restored to the first mode, so that the mode in which the unmanned aerial vehicle moves following the rotation of the gimbal 200 is restored. This ensures that an image shot by the photographing device 300 is stable, and further improves the photographing experience of the user. The specified distance threshold may be set as needed. In this exemplary embodiment, when the gimbal 200 is located at an edge of a side of the limiting buffer zone far away from the mechanical limiting position, this position is marked as 0°, and the specified distance threshold would be 5°, 10°, or other angles. In some exemplary embodiments, the unmanned aerial vehicle may be controlled to switch from the first mode to another mode (other than the second mode), the unmanned aerial vehicle is in another mode, and the unmanned aerial vehicle does not move following the rotation of the gimbal 200.

(2) The communication link between the gimbal 200 and the flight controller 100 is faulty.

Referring to FIG. 5, the determining that the gimbal 200 is in a specific working condition may include, but is not limited to, the following steps.

Step S501: Determine that the first communication link 1 is in a disconnected state.

Step S502: Determine that the second communication link 2 is in a connected state.

Step S503: Determine that the gimbal 200 is in a rotating state.

For the first communication link and the second communication link, refer to the descriptions in the foregoing exemplary embodiments. Details will not be described again herein.

In this exemplary embodiment, step S501, step S502, and step S503 may be performed simultaneously, or may be performed in sequence, for example, step S501→step S502→step S503, or step S501→step S503→step S502, or step S502→step S501→step S503, or step S502→step S503→step S501, or step S503→step S501→step S502, or step S503→step S502→step S501.

In the case where the first communication link 1 is in the disconnected state, it is possible that the first communication link 1 is permanently disconnected due to a damage of hardware, or the first communication link 1 is temporarily disconnected due to another reason. In this exemplary embodiment, the flight controller 100 can still receive data sent by the gimbal 200, but the gimbal 200 cannot receive data sent by the flight controller 100. In this case, if the unmanned aerial vehicle is in the first mode, the gimbal 200 may move following the command of speed superimposition before the disconnection of the first communication link 1, thus the posture of the gimbal 200 changes. After receiving the posture change of the gimbal 200, the unmanned aerial vehicle rotates following the gimbal 200, and therefore has a spinning problem.

In some exemplary embodiments, that the unmanned aerial vehicle enters the exception handling procedure specifically includes: clearing a rotation speed recorded by the gimbal 200, so as to stop the superimposition instruction of a target posture of the gimbal 200. Accordingly, the gimbal 200 stops rotating. Since the unmanned aerial vehicle is in the first mode, the unmanned aerial vehicle also stops rotating.

Further, before entering the exception handling procedure, the unmanned aerial vehicle further obtains duration of the first communication link 1 in the disconnected state. In this exemplary embodiment, after it is determined that the duration of the first communication link 1 in the disconnected state does not exceed first preset duration, the step of clearing a rotation speed recorded by the gimbal 200 is performed. Specifically, the first communication link 1 may be temporarily disconnected (for example, poor contact of a hardware line causes the first communication link to be temporarily disconnected). Over a time period in which the first communication link 1 is disconnected, the gimbal 200 needs to be controlled to stop rotating, so as to control the unmanned aerial vehicle to stop rotating, so that the spinning of the unmanned aerial vehicle is avoided. After the first communication link 1 is restored, if the unmanned aerial vehicle receives a new control amount, the new control amount may be sent to the gimbal 200 through the first communication link 1, thus the gimbal 200 thus resumes its rotation; and the unmanned aerial vehicle moves following the rotation of the gimbal 200. The first preset duration may be set as needed, for example, 1 s, 2 s, or 3 s.

The implementation of determining that the first communication link 1 is in a disconnected state may be of any existing type. In this exemplary embodiment, after it is determined that the duration of the gimbal 200 not receiving data sent by the unmanned aerial vehicle exceeds second preset duration, it is determined that the first communication link 1 is in a disconnected state. The second preset duration may be set based on a frequency of sending data by the flight controller 100 to the gimbal 200.

Correspondingly, the implementation of determining that the second communication link 2 is in a connected state may also of any existing type. In this exemplary embodiment, if it is determined that the duration of the unmanned aerial vehicle receiving data sent by the gimbal 200 does not exceed third preset duration, it is determined that the second communication link 2 is in a connected state. The third preset duration may be set based on a frequency of sending data by the gimbal 200 to the flight controller 100.

In addition, in this exemplary embodiment, after the rotation speed recorded by the gimbal 200 is cleared, the unmanned aerial vehicle control method may further include: controlling the unmanned aerial vehicle to automatically return, to prevent the unmanned aerial vehicle from falling after stopping rotation.

Still further, that the unmanned aerial vehicle enters the exception handling procedure further includes: after determining that the duration of the first communication link 1 in the disconnected state exceeds the first preset duration, controlling the unmanned aerial vehicle to switch from the first mode to the second mode. The second mode is the mode in which the gimbal 200 rotates following the moving of the unmanned aerial vehicle. If the duration of the first communication link 1 in the disconnected state exceeds the first preset duration, it indicates that the first communication link 1 may be permanently disconnected due to the damage of a hardware line. In this case, the unmanned aerial vehicle needs to be forced to exit the first mode, so that the unmanned aerial vehicle can be prevented from generating a spinning phenomenon. In addition, after the unmanned aerial vehicle is controlled to switch from the first mode to the second mode, when it is determined that the first communication link 1 is restored to the connected state, the unmanned aerial vehicle is controlled to switch from the second mode to the first mode, thereby restoring the mode in which the unmanned aerial vehicle moves following rotation of the gimbal 200.This ensures the stability of an image shot by the photographing device 300, and further improves photographing experience of the user.

Corresponding to the unmanned aerial vehicle control method in the foregoing exemplary embodiments, some exemplary embodiments of the present disclosure further provides an unmanned aerial vehicle.

Referring to FIG. 6, the unmanned aerial vehicle in this exemplary embodiment may include a body, a gimbal 200 carried on the body, and at least one processor, where the at least one processor is communicatively connected to the gimbal 200.

The at least one processor may be a central processing unit (CPU). The at least one processor may further include a hardware chip. The hardware chip may be an application-specific integrated circuit (ASIC), a programmable logic device (PLD), or a combination thereof. The PLD may be a complex programmable logic device (CPLD), a field-programmable gate array (FPGA), a generic array logic (GAL), or any combination thereof.

In this exemplary embodiment, the at least one processor may be a flight controller 100, or may be a flight controller 100 and a gimbal controller, or may be an independent controller disposed on the body.

The at least one processor in this exemplary embodiment may be configured to: determine that the unmanned aerial vehicle is in a first mode, where the first mode includes a mode in which the unmanned aerial vehicle moves following rotation of the gimbal 200; and when determining that the gimbal 200 is in a specific working condition, enter an exception handling procedure.

The at least one processor in this exemplary embodiment may implement the corresponding method shown in the exemplary embodiments in FIG. 2, FIG. 3, and FIG. 5. For details, refer to the descriptions of the foregoing exemplary embodiments. Details will not be described again herein.

In addition, the unmanned aerial vehicle in this exemplary embodiment may further include at least one storage medium, where the at least one storage medium may be further configured to store a program instruction. The at least one processor is in communication with the at least one storage medium and may invoke the program instruction stored in the at least one storage medium to implement the operation or steps of the corresponding method(s) of the present disclosure. The at least one storage medium may include a volatile memory (volatile memory), for example, a random access memory (RAM). The storage medium may include a non-volatile memory, for example, a flash memory, a hard disk drive (HDD), or a solid-state drive (SSD). The storage medium may further include a combination of all or some of the foregoing types of storage medium.

In addition, some exemplary embodiments of the present disclosure may further provide a computer-readable storage medium, where the computer-readable storage medium stores a computer program, and when the program is executed by a processor, the steps of the unmanned aerial vehicle control method in the foregoing embodiment are implemented.

A person of ordinary skill in the art may understand that all or some of the processes of the methods in the embodiments may be implemented by a computer program instructing relevant hardware. The program may be stored in a computer-readable storage medium. When the program runs, the processes of the methods in the embodiments are executed. The at least one storage medium may include: a magnetic disk, an optical disc, a read-only memory (ROM), or a random access memory (RAM).

What is disclosed above is merely some exemplary embodiments of the present disclosure, and is certainly not intended to limit the scope of protection of the present disclosure. Therefore, equivalent variations made in accordance with the claims of the present disclosure shall fall within the scope of the present disclosure.

What is claimed is:

1. A method for controlling an unmanned aerial vehicle, comprising:
determining that the unmanned aerial vehicle is in a first mode, in which the unmanned aerial vehicle moves following a rotation of a gimbal carried by the unmanned aerial vehicle; and
after determining that the gimbal is in a specific working condition, entering an exception handling procedure.

2. The method according to claim 1, wherein the determining that the gimbal is in a specific working condition includes:
determining that the gimbal entering a limiting buffer zone at a first speed; and
determining that the gimbal is at a second speed to drive the unmanned aerial vehicle to move.

3. The method according to claim 2, wherein the determining that the gimbal is in a specific working condition further includes:
determining that a first communication link and a second communication link are both in a connected state, wherein
the first communication link transmits data from the unmanned aerial vehicle to the gimbal, and the second communication link transmits data from the gimbal to the unmanned aerial vehicle.

4. The method according to claim 2, further comprising: after determining that the gimbal is in the specific working condition and before entering the exception handling procedure:
determining that the unmanned aerial vehicle receives no speed control instruction sent by a remote control device; or
determining that the unmanned aerial vehicle receives a speed control instruction sent by a remote control device, wherein the speed control instruction includes that a yaw speed of the unmanned aerial vehicle is 0.

5. The method according to claim 4, wherein the entering of the exception handling procedure includes:
controlling the unmanned aerial vehicle to switch from the first mode to a second mode in which the gimbal rotates following moving of the unmanned aerial vehicle.

6. The method according to claim 5, further comprising, after the controlling of the unmanned aerial vehicle to switch from the first mode to the second mode:
after determining that a current distance between the gimbal and the limiting buffer zone is greater than a specified distance threshold, restoring the unmanned aerial vehicle to the first mode.

7. An unmanned aerial vehicle, comprising:
a body;
a gimbal, carried on the body;
at least one storage medium to store a set of instructions for controlling the unmanned aerial vehicle; and
at least one processor in communication with the at least one storage medium and the gimbal to execute, during an operation, the set of instructions to:
determine that the unmanned aerial vehicle is in a first mode in which the unmanned aerial vehicle moves following a rotation of the gimbal; and
after determining that the gimbal is in a specific working condition, enter an exception handling procedure.

8. The unmanned aerial vehicle according to claim 7, wherein to determine that the gimbal is in the specific working condition, the at least one processor further:
determines that the gimbal enters a limiting buffer zone at a first speed; and
determines that the gimbal is at a second speed to drive the unmanned aerial vehicle to move.

9. The unmanned aerial vehicle according to claim 8, wherein to determine that the gimbal is in the specific working condition, the at least one processor further:
determines that a first communication link and a second communication link are both in a connected state, wherein
the first communication link is configured to transmit data from the unmanned aerial vehicle to the gimbal, and the second communication link is configured to transmit data from the gimbal to the unmanned aerial vehicle.

10. The unmanned aerial vehicle according to claim 8, wherein after determining that the gimbal is in the specific working condition and before entering the exception handling procedure, the at least one processor further: determines that the unmanned aerial vehicle receives no speed control instruction sent by a remote control device; or
determines that the unmanned aerial vehicle receives a speed control instruction sent by a remote control device and the speed control instruction includes that a yaw speed of the unmanned aerial vehicle is 0.

11. The unmanned aerial vehicle according to claim 10, wherein to enter the exception handling procedure, the at least one processor further:
controls the unmanned aerial vehicle to switch from the first mode to a second mode in which the gimbal rotates following moving of the unmanned aerial vehicle.

12. The unmanned aerial vehicle according to claim 11, wherein after controlling the unmanned aerial vehicle to switch from the first mode to the second mode, the at least one processor further:
restores the unmanned aerial vehicle to the first mode, when a current distance between the gimbal and the limiting buffer zone is greater than a distance threshold.

13. The unmanned aerial vehicle according to claim 7, wherein to determine that the gimbal is in a specific working condition, the at least one processor further:
determines that a first communication link is in a disconnected state;
determines that a second communication link is in a connected state; and
determines that the gimbal is in a rotating state, wherein the first communication link is configured to transmit data from the unmanned aerial vehicle to the gimbal, and the second communication link is configured to transmit data from the gimbal to the unmanned aerial vehicle.

14. The unmanned aerial vehicle according to claim 13, wherein to enter the exception handling procedure, the at least one processor further:
clears a rotation speed recorded by the gimbal.

15. The unmanned aerial vehicle according to claim 14, wherein before entering the exception handling procedure, the at least one processor further:
obtains duration of the first communication link in the disconnected state; and
after determining that the duration of the first communication link in the disconnected state does not exceed first preset duration, clears the rotation speed recorded by the gimbal.

16. The unmanned aerial vehicle according to claim 15, wherein to enter the exception handling procedure, the at least one processor further:
when determining that the duration of the first communication link in the disconnected state exceeds the first preset duration, controls the unmanned aerial vehicle to switch from the first mode to a second mode in which the gimbal rotates following moving of the unmanned aerial vehicle.

17. The unmanned aerial vehicle according to claim 16, wherein after controlling the unmanned aerial vehicle to switch from the first mode to the second mode, the at least one processor further:
when determining that the first communication link is restored to the connected state, controls the unmanned aerial vehicle to switch from the second mode to the first mode.

18. The unmanned aerial vehicle according to claim 14, wherein after clearing the rotation speed recorded by the gimbal, the at least one processor further:
controls the unmanned aerial vehicle to automatically return.

19. The unmanned aerial vehicle according to claim 13, wherein to determine that the first communication link is in the disconnected state, the at least one processor further:
determines that duration in which the gimbal does not receive the data from the unmanned aerial vehicle exceeds second preset duration.

20. The unmanned aerial vehicle according to claim 13, wherein to determine that a second communication link is in a connected state, the at least one processor further:
determines that duration in which the unmanned aerial vehicle receives the data from the gimbal does not exceed third preset duration.
